(19) United States
(12) Patent Application Publication
(10) Pub. No.: US 2026/0337058 A1
(43) Pub. Date: Oct. 29, 2026

(54) SELF-CONSISTENT RESOURCEFUL TREATMENT APPARATUS AND METHOD FOR SALT-CONTAINING WASTEWATER AND HYDROCHLORIC ACID-CONTAINING WASTE GAS

(71) Applicants: HUBEI TAISHENG CHEMICAL CO., LTD, Yichang, Hubei (CN); WUHAN ZHENGQINGHE ENVIRONMENTAL PROTECTION TECHNOLOGY DEVELOPMENT CO., LTD, Wuhan, Hubei (CN)

(72) Inventors: CHANG LIU, Yichang, Hubei (CN); Yiqun TIAN, Yichang, Hubei (CN); Houying GUI, Yichang, Hubei (CN); Jie CAO, Yichang, Hubei (CN); Shaoyong GUI, Yichang, Hubei (CN); Chunxue PENG, Yichang, Hubei (CN); Jing NING, Yichang, Hubei (CN); Rui ZHANG, Yichang, Hubei (CN); Yuan LIU, Yichang, Hubei (CN); Lizhong QIN, Yichang, Hubei (CN); Sanliu LIU, Yichang, Hubei (CN); Chengqiang LI, Yichang, Hubei (CN); Maosheng WU, Yichang, Hubei (CN); Wei WANG, Yichang, Hubei (CN)

(73) Assignees: HUBEI TAISHENG CHEMICAL CO., LTD, Yichang, Hubei (CN); WUHAN ZHENGQINGHE ENVIRONMENTAL PROTECTION TECHNOLOGY DEVELOPMENT CO., LTD, Wuhan, Hubei (CN)

(21) Appl. No.: 19/116,238

(22) PCT Filed: Jun. 26, 2023
(86) PCT No.: PCT/CN2023/102416

§ 371 Date: Mar. 27, 2025

(30) Foreign Application Priority Data
Oct. 8, 2022 (CN) 202211221086.1

(51) Int. Cl. C02F 1/28; B01D 53/14; B01D 53/18; C02F 101/12

(52) U.S. Cl. CPC C02F 1/28; B01D 53/1412; B01D 53/1456; B01D 53/18; C02F 2101/12; C02F 2201/004; C02F 2201/005; C02F 2209/20; C02F 2209/42

(57) ABSTRACT

Provided is a self-consistent resourceful treatment apparatus and self-consistent resourceful treatment method for salt-containing wastewater and hydrochloric acid-containing waste gas, which belongs to the technical field of industrial wastewater and waste gas treatment. In the method, the salt-containing wastewater and hydrochloric acid-containing waste gas are simultaneously charged into a self-consistent absorption and precipitation reactor for self-consistent absorption reaction; NaCl crystals are gradually precipitated from the salt in the salt-containing wastewater by a common ion effect to obtain a solid-liquid mixture which is subjected to settling and separation to obtain the industrial-grade salt and industrial-grade hydrochloric acid.

### FIELD

The present invention relates to the technical field of industrial wastewater and waste gas treatment, and particularly relates to a self-consistent resourceful treatment method for salt-containing wastewater and hydrochloric acid-containing waste gas.

### BACKGROUND

Industrial development plays a main role in environmental pollution, and the discharge and treatment of saline wastewater is the key to solve the problem of environmental pollution. At present, most of salt-containing wastewater treatment technologies are biochemical treatment methods, but for variable and refractory organic pollutants, it is often difficult to completely implement conventional biochemical treatment processes, and consequently, the treated wastewater cannot meet the discharge standards. There are also studies on the use of natural evaporation crystallization and mechanical evaporation methods to treat salt-containing wastewater, the natural evaporation crystallization technology needs a large evaporation pond for natural evaporation, because of the large area required and low efficiency, it cannot meet the requirements for the treatment of salt-containing wastewater. Compared with the natural evaporation crystallization technology, the mechanical evaporation technology needs a small space for devices and has high efficiency. However, because mechanical evaporation is easy to cause scales on the inner wall of an evaporator system, the generated salt is easy to block a channel, and the pipeline is easily easy corroded after a long time. Therefore, it is necessary to develop a more efficient, pipeline blockage prevented, and energy-efficient method for treating the salt-containing wastewater.

Industrial production is often accompanied by the production of hydrochloric acid-containing waste gas, a large amount of hydrogen chloride gas in the waste gas has high corrosiveness, and if directly discharged to the external environment, it will cause great pollution to the environment. At present, the waste gas will be absorbed before discharge, so as to absorb the highly corrosive gas inside. Most of existing exhaust gas absorption technologies are carried out by means of conventional absorption towers, the resulted absorption effect of hydrogen chloride is poor, and there is still more hydrogen chloride gas remaining in the discharged exhaust gas.

Therefore, how to develop a method for performing, co-treating and resourceful treatment on the salt-containing wastewater and hydrochloric acid-containing waste gas is a technical problem that needs to be solved at present.

### SUMMARY

An objective of the present invention is to provide a self-consistent resourceful treatment method for salt-containing wastewater and hydrochloric acid-containing waste gas to solve the technical problems of high scaling possibility, low absorption efficiency, high treatment cost and high environment hazards caused by separate treatment on the salt-containing wastewater and the hydrochloric acid-containing waste gas in the related technology.

In order to achieve the above objective, the present invention provides the following technical solutions:
a self-consistent resourceful treatment apparatus for salt-containing wastewater and hydrochloric acid-containing waste gas is provided, a self-consistent absorption reactor includes an absorption tower, a circulating cooler and a forced cooling circulating pump; a wastewater inlet is formed in a bottom end of the absorption tower, and the bottom end of the absorption tower is connected to a bottom end of the circulating cooler by means of a pipeline; a pipeline at a top end of the circulating cooler extends into the absorption tower; and the forced cooling circulating pump is arranged on a pipeline, connected to the absorption tower, at the bottom end of the circulating cooler.

Further, a venturi is arranged at a top end of the absorption tower while a water inlet is formed in the bottom end; a transverse gas inlet is formed in a top end of the venturi while a tubular horn-shaped nozzle is arranged at a bottom end; a longitudinal liquid inlet of the venturi is in communication with one end of an absorption liquid circulating pump by means of a pipeline, and the other end of the absorption liquid circulating pump is in communication with the interior of the absorption tower; and the hydrochloric acid-containing waste gas is absorbed through the gas inlet.

Further, a demister is also arranged at the top end of the absorption tower.

Further, a baffle is arranged at an outlet of a pipeline, extending into the absorption tower, at the top end of the circulating cooler.

Further, a baffle ring is also arranged on an inner wall of a position, in communication with the absorption liquid circulating pump, on the absorption tower.

Further, a liquid level meter is mounted on one side of the absorption tower.

Further, a pipeline is also arranged at the bottom end of the absorption tower and is connected to a solid-containing liquid level automatic regulating valve; a discharging valve is arranged at a bottom end of the solid-containing liquid level automatic regulating valve; and the solid-containing liquid level automatic regulating valve is linked with the discharging valve.

For the above apparatus, the present invention further provides a self-consistent resourceful treatment method for salt-containing wastewater and hydrochloric acid-containing waste gas. The method includes the following steps:
(1) charging the salt-containing wastewater and hydrochloric acid-containing waste gas into a self-consistent absorption reactor synchronously, and performing self-consistent absorption reaction to obtain absorption liquid;
(2) cooling the absorption liquid by means of a circulating cooler and a forced cooling circulating pump, and controlling the temperature of the absorption liquid to facilitate absorption of HCl in the waste gas, and
(3) continuously performing self-consistent absorption reaction on the obtained absorption liquid with the hydrochloric acid-containing waste gas by means of an absorption liquid circulating pump, precipitating solids to obtain a solid-liquid mixture, and settling and centrifugally separating the solid-liquid mixture to obtain industrial-grade salt and industrial-grade hydrochloric acid.

Further, the flow of the salt-containing wastewater is 4.0-5.0 m³/h, preferably 4.2-4.8 m³/h, and further preferably 4.5 m³/h; and the flow of the hydrochloric acid-containing waste gas is 200.0-350.0 m³/h, preferably 230.0-320.0 m³/h, and further preferably 280.0-300.0 m³/h.

Further, in steps (1) and (3), the temperature in the self-consistent absorption reaction is independently 25-35 °C, preferably 28-32 °C, and further preferably 29-31 °C; and the time for the materials maintaining in the self-consistent absorption reactor is independently 60-90 min, preferably 75-85 min, and further preferably 80 min.

Further, in step (2), the absorption liquid is cooled to 25-35 °C, preferably 22-28 °C, and further preferably 24-26 °C by means of the circulating cooler.

In the technical solution of the present invention, the self-consistent resourceful treatment method for the salt-containing wastewater and the hydrochloric acid-containing waste gas can be successfully implemented by means of the self-consistent resourceful treatment apparatus for the salt-containing wastewater and the hydrochloric acid-containing waste gas.

In another technical solution of the present invention, industrial-grade salt and industrial-grade hydrochloric acid which are obtained by resourceful treatment are provided, and are prepared by the self-consistent resourceful treatment method for the salt-containing wastewater and the hydrochloric acid-containing waste gas.

The TOC in the prepared industrial-grade salt is smaller than 5 mg/L, the purity of the industrial-grade salt is larger than 99.0%, further preferably larger than or equal to 99.3%, still further preferably larger than or equal to 99.5%, and yet still further preferably larger than or equal to 99.8%.

The prepared industrial-grade hydrochloric acid meets the requirements on qualified products, further preferably meets the requirements on first-class products, and still further preferably meets the requirements on superior products.

In some embodiments of the present invention, by the technical solutions in the present invention, a byproduct, that is the industrial salt with TOC exceeding 5000 mg/L for example, in the production of pharmaceutical raw materials and intermediates can be dissolved into a saturated solution by deionized water and then subjected to self-consistent resourceful treatment with the hydrochloric acid-containing waste gas; refined industrial salt with high quality can be obtained by the method according to the present invention, its TOC is smaller than 5 mg/L, and its quality meets the requirements of GB/T5462-2015 chlor-alkali industry.

The present invention has the beneficial effects that:

the processing method in the present invention is to perform synchronous reaction on the industrial wastewater and industrial waste gas to obtain the industrial-grade salt and industrial-grade hydrochloric acid; in the present invention, the salt-containing wastewater and the hydrochloric acid-containing waste gas are simultaneously charged into a self-consistent absorption and precipitation reactor for self-consistent absorption reaction; according to the common ion effect, NaCl crystals are gradually precipitated from the salt in the salt-containing wastewater to obtain the solid-liquid mixture, and the solid-liquid mixture is subjected to settling and separation to obtain the industrial-grade salt and the industrial-grade hydrochloric acid; and it avoids more area occupied for the required devices, and also avoids the situation that many scales are generated on the inner wall to block a salt outlet channel and easily corrodes the pipeline after a long time, so that the problems of easy scaling and low treatment efficiency due to separate treatment on the salt-containing wastewater and the hydrochloric acid-containing waste gas in the related technology can be solved. By the treatment method in the present invention, the industrial wastewater and the industrial waste gas can be subjected to synchronous reaction to obtain the industrial-grade salt, the obtained industrial-grade salt can be directly sold in the market or used in the chlor-alkali industry, and the obtained hydrochloric acid can be used as a raw material for producing a refrigerant CaCl₂; and therefore, resourceful treatment is realized at the same time.

The obtained industrial-grade salt can be directly sold in the market or used in the chlor-alkali industry, and the obtained industrial hydrochloric acid can be used as the raw material for producing the refrigerant CaCl₂. The treatment method in the present invention is different from a conventional method implemented by a spray type absorption reactor, tower plates and fillers are not used, so the problem that the reactor is blocked due to salt precipitation is solved.

According to the present invention, the self-consistent absorption reactor is provided with the forced cooling circulation pump and the circulating cooler, so the temperature in the absorption tower can be greatly reduced, and heat exchange can be implemented; the venturi is arranged at the top end of the absorption tower, thus the hydrochloric acid-containing waste gas can be continuously pumped and absorbed by absorption circulating liquid flow, normal operation of the reaction in the absorption tower is ensured, and then the salt and industrial hydrochloric acid can be prepared. HCl in the hydrochloric acid-containing waste gas is completely absorbed by the wastewater to generate hydrochloric acid, and the salt in the wastewater is completely precipitated to generate the salt particles according to the common ion effect; therefore, NaCl in the wastewater is completely precipitated to generate the industrial salt, and the HCl in the waste gas is absorbed to generate the industrial hydrochloric acid, so that resourceful utilization is realized; and waste utilization is realized while the wastewater and the waste gas are treated, the cost is further reduced, and the resourceful treatment of the salt-containing wastewater and the hydrochloric acid-containing waste gas is realized. The self-consistent absorption reactor according to the present invention does not need the tower plates and the fillers, the gas-liquid contact reaction is directly performed, and the common ion effect is generated in the reactor to precipitate the salt. The following reactions are performed in the reactor:

NaCl (liquid)+HCl (gas)→NaCl (solid, commercially available)+HCl (liquid, raw materials for preparing a refrigerant CaCl₂)).

In the technical solution of the present invention, the self-consistent absorption reactor under its specific and compact structure involves venturi absorption, laminar flow enrichment, ordered crystal growth, forced circular cooling, efficient liquid-solid separation and processes the like; the efficient stable control on material balance and thermodynamic equilibrium is implemented by model simulation calculation and unique innovative thinking; and therefore, the resourceful treatment of the salt-containing wastewater and the hydrochloric acid-containing waste gas can be realized, refining of coarse salt can be realized, and the obtained crystal salt is high in purity and can be efficiently and industrially used.

### BRIEF DESCRIPTION OF THE DRAWINGS

FIG. 1 is a structural schematic diagram of a self-consistent absorption reactor according to the present invention, in which, 1—absorption tower, 2—circulating cooler, 3—liquid level meter, 4—solid-containing liquid level automatic adjusting valve, 5—demister, 6—venturi, 7—baffle, 8—absorption liquid circulating pump, 9—forced cooling circulating pump, 10—discharging valve, 11—baffle ring, 12—wastewater inlet, 13—transverse gas inlet, 14—exhaust gas outlet.

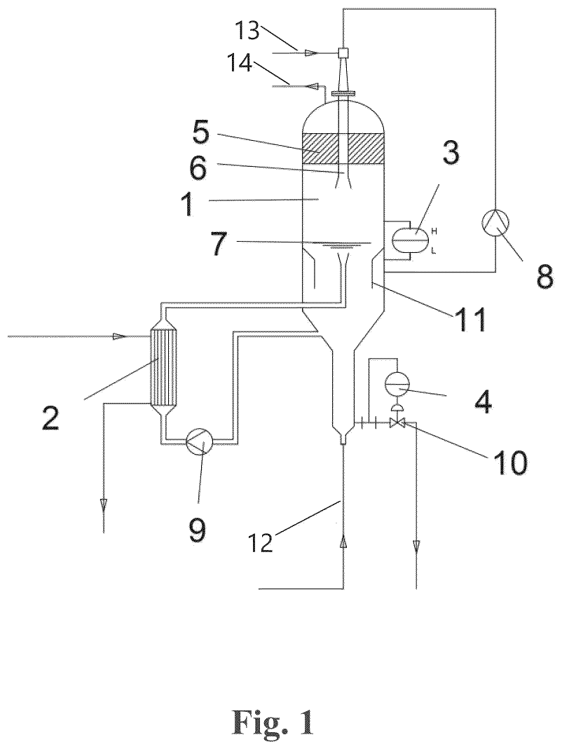

FIG. 2 is a microphotograph of NaCl crystals obtained in an Example 1.

### DETAILED DESCRIPTION

The present invention provides a self-consistent resourceful treatment method for salt-containing wastewater and hydrochloric acid-containing waste gas, which includes the following steps:
1) charging the salt-containing wastewater and hydrochloric acid-containing waste gas into a self-consistent absorption reactor synchronously, and performing self-consistent absorption reaction to obtain absorption liquid;
2) cooling the absorption liquid by means of a circulating cooler and a forced cooling circulating pump, and controlling the temperature of the absorption liquid to facilitate absorption of HCl in the waste gas; and
3) continuously performing self-consistent absorption reaction on the obtained absorption liquid with the hydrochloric acid-containing waste gas by means of an absorption liquid circulating pump, precipitating solids to obtain a solid-liquid mixture, and settling and centrifugally separating the solid-liquid mixture to obtain industrial-grade salt and industrial-grade hydrochloric acid.

In the present invention, the salt-containing wastewater contains NaCl, and the hydrochloric acid-containing waste gas contains HCl gas.

In the present invention, the flow of the salt-containing wastewater is 4.0-5.0 m³/h, preferably 4.2-4.8 m³/h, and further preferably 4.5 m³/h; and the flow of the hydrochloric acid-containing waste gas is 200.0-350.0 m³/h, preferably 230.0-320.0 m^{3/1} and further preferably 280.0-300.0 m³/h.

In the present invention, in step 1) and step 3), the temperature in the self-consistent absorption reaction is independently 25-35 °C, preferably 28-32 °C, and further preferably 29-31 °C; and the time for the materials maintaining in the self-consistent absorption reactor is independently 60-90 min, preferably 75-85 min, and further preferably 80 min.

In the present invention, in step 2), the absorption liquid is cooled to 25-35 °C, preferably 22-28 °C, and further preferably 24-26 °C by means of the circulating cooler.

In the present invention, the self-consistent resourceful treatment method for the salt-containing wastewater and the hydrochloric acid-containing waste gas can also be used for refining coarse salt.

In the present invention, the self-consistent absorption reactor includes an absorption tower 1, a circulating cooler 2 and a forced cooling circulation pump 9; a wastewater inlet 12 is formed in a bottom end of the absorption tower 1, and the bottom end of the absorption tower 1 is connected to a bottom end of the circulating cooler 2 by means of a pipeline; a pipeline at a top end of the circulating cooler 2 extends into the absorption tower 1; the forced cooling circulation pump 9 is arranged on a pipeline, connected to the absorption tower 1, at the bottom end of the circulating cooler 2; a shell side water inlet is formed in the top end of the circulating cooler 2 while a shell side water outlet is formed in the bottom end, water enters from the top end and flows out from the bottom end and exchanges heat with tube side absorption liquid in the circulating cooler 2 for cooling; and the absorption liquid is subjected to forced cooling by means of the circulating cooler 2 and the forced cooling circulation pump 9, so that the reaction temperature can be quickly reduced. A cooling water inlet and a cooling water outlet are respectively in an upper part and a lower part of the circulating cooler 2.

In the present invention, a venturi 6 is arranged at the top end of the absorption tower 1 while a water inlet is formed in the bottom end; the venturi 6 is used for absorbing the hydrochloric acid-containing exhaust gas; a tubular horn-shaped nozzle is arranged at a bottom end of the venturi 6 while a transverse gas inlet 13 is formed in the top end; a longitudinal liquid inlet of the venturi 6 is in communication with one end of the absorption liquid circulating pump 8 by means of a pipeline, and the other end of the absorption liquid circulating pump 8 is in communication with the interior of the absorption tower 1; and the hydrochloric acid-containing waste gas is absorbed by means of the gas inlet. An exhaust gas outlet 14 is also formed in the top end of the absorption tower 1, and exhaust gas from the exhaust gas outlet is discharged into an exhaust gas absorption device.

In the present invention, a demister 5 is further arranged at the top end of the absorption tower 1 and used for removing liquid foam in residual exhaust gas.

In the present invention, a baffle 7 is arranged at an outlet of a pipeline, extending into the absorption tower 1, at the top end of the circulating cooler 2, and absorption liquid in the pipeline is converted into laminar flow from turbulent flow by means of the baffle 7, which facilitates the settling of salt particles.

In the present invention, a baffle ring 11 is further arranged on an inner wall of a position, in communication with the absorption liquid circulating pump 8, on the absorption tower 1 and used for separating an absorption reaction area from a precipitation settling area so that it can be guaranteed that circulating absorption liquid pumped in by the absorption liquid circulating pump 8 carries the salt particles as little as possible, which facilitates the normal operation of the absorption liquid circulating pump, and also facilitates the absorption of HCl in the waste gas as well as the precipitation settling of the salt particles.

In the present invention, the baffle 7 and the baffle ring 11 are arranged in the self-consistent absorption reactor, the range, enclosed by the baffle ring, of a lower layer of the baffle, a cone at a lower part of the absorption reactor and a thin and long “salt leg” part form a laminar flow area, which facilitates the settling and enrichment of solids, and ensures that the circulating absorption liquid does not contain solid particles or contains the solid particles as little as possible, thus the pipeline can be prevented from being blocked, and the liquid-solid separation effect is improved.

In the present invention, a liquid level meter 3 is installed on one side of the absorption tower 1 and is used for determining the liquid level in the absorption tower 1.

In the present invention, a pipeline is further arranged at the bottom end of the absorption tower 1 and connected to a solid-containing liquid level automatic adjusting valve 4; a discharging valve 10 is arranged at a bottom end of the solid-containing liquid level automatic adjusting valve 4; the solid-containing liquid level automatic adjusting valve 4 is linked with the discharging valve 10 and used for controlling the solid-containing liquid level of the absorption tower; and the discharging valve 10 is used for controlling discharging, and salt and industrial hydrochloric acid are removed by means of a centrifugal machine.

In the present invention, the salt-containing wastewater is fed from the bottom end of the absorption tower 1, the hydrochloric acid-containing waste gas is absorbed through the transverse gas inlet formed in the top end of the venturi 6 and is forcibly mixed with the absorption liquid discharged from the absorption liquid circulating pump 8 by means of the venturi 6; then the mixture is fed into the absorption tower 1, the wastewater absorbs HCl in the waste gas to generate hydrochloric acid, and salt in the wastewater is gradually or even completely precipitated due to the common ion effect; salt particles and industrial hydrochloric acid settle to the bottom end of the absorption tower 1 and are discharged by means of the discharging valve 10, and the salt and the industrial hydrochloric acid are separated by means of the centrifugal machine; and the salt can be sold as industrial salt after the quality reaches the standard by analysis, and the industrial hydrochloric acid can be used as a raw material for preparing the refrigerant CaCl₂. The waste gas absorbing HCl is fed into other waste gas treatment apparatus by means of the demister 5 and is discharged after reaching the standard; the absorption liquid in the absorption tower 1 will be affected by the forced cooling circulating pump 9 and enters the circulating cooler 2 through the pipeline, connected to the circulating cooler 2, at the bottom end of the absorption tower 1; and the cooled absorption liquid enters the absorption tower 1 through the pipeline at the top end of the circulating cooler 2 to form turbulent flow, the turbulent flow is blocked by the baffle 7 in the absorption tower 1 to form laminar flow, thus fluid rolling is relieved, which facilitates the settlement of the generated salt particles.

The technical solutions provided by the present invention are described in detail below in conjunction with the embodiments, but they cannot be understood as limiting the scope of protection of the present invention.

### Example 1

Salt-containing wastewater and hydrochloric acid-containing waste gas were simultaneously and continuously charged into a self-consistent absorption reactor, in which, the charging flow of the salt-containing wastewater was 4.3 m³/h, and the charging flow of the hydrochloric acid-containing waste gas was 260.0 m³/h.

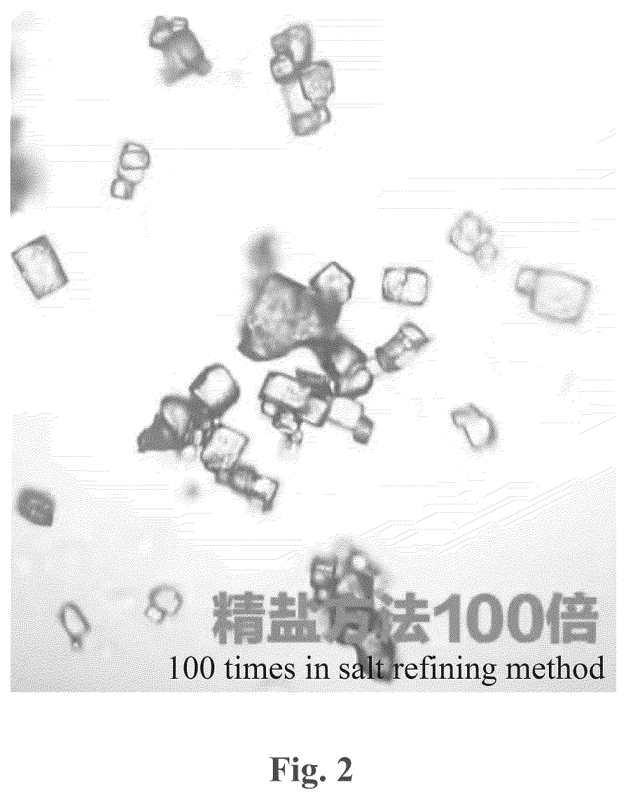

The salt-containing wastewater and the hydrochloric acid-containing waste gas were subjected to self-consistent absorption reaction in a reactor, and the absorption reaction was maintained for 65 min; absorption liquid in an absorption tower was cooled by means of a circulating cooler, thereby decreasing the reaction temperature; after the absorption liquid was cooled to 25 °C, self-consistent absorption reaction was further performed on the absorption liquid and the hydrochloric acid-containing waste gas absorbed by a venturi by means of an absorption liquid circulating pump, in the continuous absorption reaction, NaCl crystals were gradually precipitated from salt in the salt-containing wastewater due to the common ion effect; the NaCl crystals were completely separated out when the concentration of hydrochloric acid was 31% by analysis; and an obtained solid-liquid mixture was separated by a centrifugal machine to obtain industrial-grade salt solid and industrial-grade hydrochloric acid liquid. The industrial salt was measured according to the national standard GB/T5462-2015, and each index met the requirement. In this example, the self-consistent absorption reactor with the above structure was adopted, a laminar flow area was formed in a gas-liquid mixing area, the NaCl crystals grew orderly, the NaCl crystals were transparent in the orderly crystal growth process, and any impurity influencing the quality of NaCl was not wrapped in the crystallization process, so that refined NaCl was realized and cloud be used in the chlor-alkali industry; and as shown in FIG. 2, it is a microphotograph of the NaCl crystals orderly growing in the laminar flow area, which shows that the NaCl crystals are uniform in granularity, transparent and free from wrapping. The liquid industrial-grade hydrochloric acid meets the superior product index in GB/T 320-2006.

### Example 2

Salt-containing wastewater and hydrochloric acid-containing waste gas were simultaneously and continuously charged into a self-consistent absorption reactor, in which, the charging flow of the salt-containing wastewater was 4.5 m³/h, and the charging flow of the hydrochloric acid-containing waste gas was 290.0 m³/h.

The salt-containing wastewater and the hydrochloric acid-containing waste gas were subjected to self-consistent absorption reaction in a reactor, and the absorption reaction was maintained for 75 min; absorption liquid in an absorption tower was cooled by means of a circulating cooler, thereby decreasing the reaction temperature; after the absorption liquid was cooled to 28 °C, self-consistent absorption reaction was further performed on the absorption liquid and the hydrochloric acid-containing waste gas absorbed by a venturi by means of an absorption liquid circulating pump; in the continuous absorption reaction, NaCl crystals were gradually precipitated from salt in the salt-containing wastewater due to the common ion effect; the NaCl crystals were completely precipitated when the concentration of hydrochloric acid was 30.5% by analysis; and an obtained solid-liquid mixture was separated by a centrifugal machine to obtain industrial-grade salt solid and industrial-grade hydrochloric acid liquid. The industrial salt was measured according to the national standard GB/T5462-2015, and each index met the requirement. The obtained microphotograph of the NaCl crystals was basically the same as that in the Example 1, and showed that the NaCl crystals were uniform in granularity, transparent and free from wrapping. The liquid industrial-grade hydrochloric acid meets the superior product index in GB/T 320-2006.

### Example 3

Salt-containing wastewater and hydrochloric acid-containing waste gas were simultaneously and continuously charged into a self-consistent absorption reactor, in which, the charging flow of the salt-containing wastewater was 5.0 m³/h, and the charging flow of the hydrochloric acid-containing waste gas was 350 m³/h.

The salt-containing wastewater and the hydrochloric acid-containing waste gas were subjected to self-consistent absorption reaction in a reactor, and the absorption reaction was maintained for 75 min; absorption liquid in an absorption tower was cooled by means of a circulating cooler, thereby decreasing the reaction temperature; after the absorption liquid was cooled to 33 °C, self-consistent absorption reaction was further performed on the absorption liquid and the hydrochloric acid-containing waste gas absorbed by a venturi by means of an absorption liquid circulating pump; in the continuous absorption reaction, NaCl crystals were gradually precipitated from salt in the salt-containing wastewater due to the common ion effect; the NaCl crystals were completely precipitated when the concentration of hydrochloric acid was 31.5% by analysis; and an obtained solid-liquid mixture was separated by a centrifugal machine to obtain industrial-grade solid salt and industrial-grade liquid hydrochloric acid. The industrial salt was measured according to the national standard GB/T5462-2015, and each index met the requirement. The obtained microphotograph of the NaCl crystals was basically the same as that in the Example 1, and showed that the NaCl crystals were uniform in granularity, transparent and free from wrapping. The liquid industrial-grade hydrochloric acid meets the superior product index in GB/T 320-2006.

The industrial-grade salt obtained in the Example 1 to Example 3 was subjected to purity measurement according to the national standard GB/T5462-2015, and the result is shown in the following Table 1.

TABLE 1
Purity of industrial-grade salt obtained in Example 1 to Example 3

| | Purity of salt (%) |
|---|---|
| Example 1 | 99.5 |
| Example 2 | 99.3 |
| Example 3 | 99.8 |

According to the above examples, the present invention provides the self-consistent resourceful treatment method for the salt-containing wastewater and the hydrochloric acid-containing waste gas. According to the treatment method in the present invention, two industrial pollutants are subjected to the self-consistent reaction and can be removed at the same time, and moreover, high-purity salt for industrial use is generated. The self-consistent absorption reactor according to the present invention cannot cause the problem that the salt blocks and corrodes the pipeline, and can efficiently and continuously treat the salt-containing wastewater and the hydrochloric acid-containing waste gas; and the industrial hydrochloric acid obtained after the reaction can be used as the raw material for preparing the refrigerant CaCl₂). The treatment method in the present invention is simple and easy to implement, small in area for devices, and convenient to operate and can be used for industrially treating the salt-containing wastewater and the hydrochloric acid-containing waste gas.

The foregoing is only preferred embodiments of the present invention, and it is to be noted that for those of ordinary skill in the art, on the premise of not departing from the principle of the present invention, a number of improvements and modifications can also be made, including the use of the present invention to refine the relevant coarse salt, and these improvements and modifications shall also be regarded as the scope of protection of the present invention.

1. A self-consistent resourceful treatment apparatus for salt-containing wastewater and hydrochloric acid-containing waste gas, wherein
a self-consistent absorption reactor comprises an absorption tower (1), a circulating cooler (2) and a forced cooling circulating pump (9); a bottom end of the absorption tower (1) is connected to a bottom end of the circulating cooler (2) by means of a pipeline; a pipeline at a top end of the circulating cooler (2) extends into the absorption tower (1); and the forced cooling circulating pump (9) is arranged on the pipeline, connected to the absorption tower (1), at a bottom end of the circulating cooler (2).

2. The self-consistent resourceful treatment apparatus for salt-containing wastewater and hydrochloric acid-containing waste gas according to claim 1, wherein a venturi (6) is arranged at a top end of the absorption tower (1) while a water inlet (12) is formed in the bottom end; a transverse gas inlet (13) is formed in a top end of the venturi (6) while a tubular horn-shaped nozzle is arranged at a bottom end; a longitudinal liquid inlet of the venturi is in communication with one end of an absorption liquid circulating pump (8) by means of a pipeline, and the other end of the absorption liquid circulating pump (8) is in communication with the interior of the absorption tower (1); and the hydrochloric acid-containing waste gas is absorbed through the gas inlet.

3. The self-consistent resourceful treatment apparatus for salt-containing wastewater and hydrochloric acid-containing waste gas according to claim 1, wherein a demister(S) is also arranged at the top end of the absorption tower (1).

4. The self-consistent resourceful treatment apparatus for salt-containing wastewater and hydrochloric acid-containing waste gas according to claim 1, wherein a baffle (7) is arranged at an outlet of a pipeline, extending into the absorption tower (1), at the top end of the circulating cooler (2).

5. The self-consistent resourceful treatment apparatus for salt-containing wastewater and hydrochloric acid-containing waste gas according to claim 1, wherein a baffle ring (11) is also arranged on an inner wall of a position, in communication with the absorption liquid circulating pump (8), on the absorption tower (1).

6. The self-consistent resourceful treatment apparatus for salt-containing wastewater and hydrochloric acid-containing waste gas according to claim 1, wherein a liquid level meter (3) is installed on one side of the absorption tower (1).

7. The self-consistent resourceful treatment apparatus for salt-containing wastewater and hydrochloric acid-containing waste gas according to claim 1, wherein a pipeline is also arranged at the bottom end of the absorption tower (1) and is connected to a solid-containing liquid level automatic regulating valve (4); a discharging valve (10) is arranged at a bottom end of the solid-containing liquid level automatic regulating valve (4); and the solid-containing liquid level automatic regulating valve (4) is linked with the discharging valve (10).

8. A self-consistent resourceful treatment method for salt-containing wastewater and hydrochloric acid-containing waste gas, comprising the following steps:
(1) charging the salt-containing wastewater and hydrochloric acid-containing waste gas into a self-consistent absorption reactor synchronously, and performing self-consistent absorption reaction to obtain absorption liquid;
(2) cooling the absorption liquid by means of a circulating cooler and a forced cooling circulating pump, and controlling the temperature of the absorption liquid to facilitate absorption of HCl in the waste gas; and
(3) continuously performing self-consistent absorption reaction on the obtained absorption liquid with the hydrochloric acid-containing waste gas by means of an absorption liquid circulating pump, precipitating solids to obtain a solid-liquid mixture, and settling and centrifugally separating the solid-liquid mixture to obtain industrial-grade salt and industrial-grade hydrochloric acid.

9. The self-consistent resourceful treatment method for salt-containing wastewater and hydrochloric acid-containing waste gas according to claim 8, wherein the flow of the salt-containing wastewater is 4.0-5.0 m³/h, preferably 4.2-4.8 m³/h, and further preferably 4.5 m³/h; and the flow of the hydrochloric acid-containing waste gas is 200.0-350.0 m³/b, preferably 230.0-320.0 m³/h, and further preferably 280.0-300.0 m³/h.

10. The self-consistent resourceful treatment method for salt-containing wastewater and hydrochloric acid-containing waste gas according to claim 9, wherein in steps (1) and (3), the temperature in the self-consistent absorption reaction is independently 25-35 °C, preferably 28-32 °C, and further preferably 29-31 °C, and the time for the materials maintaining in the self-consistent absorption reactor is independently 60-90 min, preferably 75-85 min, and further preferably 80 min.

11. The self-consistent resourceful treatment method for salt-containing wastewater and hydrochloric acid-containing waste gas according to claim 10, wherein in step (2), the absorption liquid is cooled to 25-35 °C, preferably 22-28 °C, and further preferably 24-26 °C by means of the circulating cooler.

12. The self-consistent resourceful treatment method for salt-containing wastewater and hydrochloric acid-containing waste gas according to claim 8, wherein the self-consistent absorption reactor comprises an absorption tower (1), a circulating cooler (2) and a forced cooling circulating pump (9); a bottom end of the absorption tower (1) is connected to a bottom end of the circulating cooler (2) by means of a pipeline; a pipeline at a top end of the circulating cooler (2) extends into the absorption tower (1); and the forced cooling circulating pump (9) is arranged on the pipeline, connected to the absorption tower (1), at a bottom end of the circulating cooler (2).

13. Industrial-grade salt and industrial-grade hydrochloric acid obtained by resourceful preparation, being prepared by the self-consistent resourceful treatment method for salt-containing wastewater and hydrochloric acid-containing waste gas according to claim 8.

14. The industrial-grade salt and industrial-grade hydrochloric acid obtained by resourceful preparation according to claim 13, wherein the TOC in the prepared industrial-grade salt is smaller than 5 mg/L, the purity of the industrial-grade salt is larger than 99.0%, further preferably larger than or equal to 99.3%, still further preferably larger than or equal to 99.5%, and yet still further preferably larger than or equal to 99.8%.

15. The industrial-grade salt and industrial-grade hydrochloric acid obtained by resourceful preparation according to claim 13, wherein the prepared industrial-grade hydrochloric acid meets the requirements on qualified products, further preferably meets the requirements on first-class products, and still further preferably meets the requirements on superior products.
